(19) United States
(12) Patent Application Publication
(10) Pub. No.: US 2026/0344760 A1
(43) Pub. Date: Nov. 5, 2026

(54) AEROSOL GENERATING APPARATUS

(71) Applicant: Imperial Tobacco Limited, Bristol (GB)

(72) Inventors: Lik Hon, Amsterdam (NL); Zhuoran Li, Beijing (CN); Fucheng Yu, Beijing (CN); David Thomas, Bristol (GB); Robert Wallace, Bristol (GB); Phillip Taylor, Bristol (GB); Jan Hyla, Bristol (GB)

(21) Appl. No.: 19/487,399

(22) PCT Filed: May 26, 2023
(86) PCT No.: PCT/CN2023/096465

§ 371 Date: Nov. 24, 2025

(51) Int. Cl. A24F 40/42; A24F 40/10; A24F 40/44; A24F 40/51

(52) U.S. Cl. CPC A24F 40/42; A24F 40/10; A24F 40/44; A24F 40/51

(57) ABSTRACT

The present disclosure relates to a consumable for an aerosol generating apparatus, and an aerosol generating apparatus. A drawback with known aerosol generating apparatuses is that once the aerosol precursor is depleted, the heating element may overheat and/or exhibit an uncontrolled behaviour. Accordingly, there is provided a consumable (30) for an aerosol generating apparatus (1), comprising a storage portion (32) for storing a precursor material (6), a heating filament (40) for heating the precursor material (6) and a sensor arrangement (42), comprising two capacitor plates (42a, b), wherein at least a part of the storage portion (32) is arranged between the capacitor plates (42a, b), wherein the sensor arrangement (42) is adapted to determine a capacitance value related to a fill level of precursor material (6) in the storage portion (32), wherein the storage portion (32) comprises a conduit element (48) fluidly connecting the storage portion (32) to the heating filament (40) and wherein the sensor arrangement (42) is adapted to determine a capacitance value related to the fill level of precursor material (6) in the conduit element (32).

### FIELD

The present disclosure relates to a consumable for an aerosol generating apparatus, and an aerosol generating apparatus.

### BACKGROUND

A typical aerosol generating apparatus may comprise a power supply, an aerosol generating unit that is driven by the power supply, an aerosol precursor, which in use is aerosolised by the aerosol generating unit to generate an aerosol, and a delivery system for delivery of the aerosol to a user.

A drawback with known aerosol generating apparatuses is that once the aerosol precursor is depleted, the heating element may overheat and/or exhibit an uncontrolled behaviour.

In spite of the effort already invested in the development of aerosol generating apparatuses/systems further improvements are desirable.

### SUMMARY

The present disclosure provides a consumable for an aerosol generating apparatus, comprising a storage portion for storing a precursor material, a heating filament for heating the precursor material, and a sensor arrangement, comprising two capacitor plates, wherein at least a part of the storage portion is arranged between the capacitor plates, wherein the sensor arrangement is adapted to determine a capacitance value related to a fill level of precursor material in the storage portion.

In some examples, the consumable the storage portion comprises a conduit element fluidly connecting the storage portion to the heating filament and the sensor arrangement is adapted to determine a capacitance value related to the fill level of precursor material in the conduit element.

The present disclosure may further provide a set of an aerosol generating apparatus and a consumable according to the present disclosure, wherein the aerosol generating apparatus comprises a processor; and wherein the processor is adapted to determine a capacitance value related to a fill level of precursor material in the storage portion.

The present disclosure may provide a method for heater control of a consumable according to the present disclosure, which may implement any one or more features disclosed herein. The method may comprise determining a plurality of capacitance values related to a fill level of precursor material in the storage portion and control the heating filament dependent on at least one of the plurality of capacitance value or a change in capacitance value.

The present disclosure may provide a computer-readable storage medium or a computer program product comprising instructions which, when executed by a processor, cause the processor to carry out the method according to the present disclosure.

In an aerosol generating apparatus, a precursor material, in particular a liquid precursor material is heated by a heater so to aerosolize the precursor material for inhalation. A heater regularly comprises a resistive, conductive element that is powered by a power source so that its temperature increases. The precursor material is brought into contact with the heater, thereby increasing its temperature to a point where the precursor material is aerosolized. While the heater provides energy to the precursor material, the precursor material in turn provides a cooling effect on the heater by being aerosolized. In other words, a heater that is in contact with precursor material has a lower temperature than the same heater, powered by the same amount of energy without the contact with precursor material. In case there is no contact with precursor material, the heater would regularly be in contact with air, which provides a reduced cooling effect. A heater in contact with precursor material thus exhibits a lower temperature than a heater in contact with air alone.

The difference in temperature may be such that a temperature in excess of the nominal temperature when in contact with precursor material may be undesirable. For example, an aerosol generating apparatus may be designed for a certain heater temperature coinciding with the aerosolization of precursor material. Further, an aerosol generating apparatus may not be specifically designed for a certain heater temperature occurring when no precursor material provides a cooling effect to the heater. It may thus be desirable to avoid a heater temperature occurring when no precursor material is available. In order to avoid such an increased heater temperature, it may be beneficial to detect the presence or absence of precursor material at the heater. In case the absence of precursor material is detected, the aerosol generating apparatus may control the heater in a way so to reduce the heater temperature. E.g., energy provided to the heater may be reduced or even be completely switched off.

In order to react to a situation where insufficient precursor material is available at the heater, it may be desirable to detect the general availability of precursor material to the aerosol generating apparatus, e.g., in a consumable. In order to detect the general availability of precursor material, the present disclosure proposes to provide a consumable for an aerosol generating apparatus with a sensor arrangement that is able to determine the general availability of precursor material. In one example, the sensor arrangement comprises capacitance measurement means, e.g., to capacitor plates, arranged within the consumable capable of providing a capacitance value that is related to a fill level of precursor material in the consumable, in particular within a storage portion of the consumable. Dependent on the capacitance value, the aerosol generating apparatus may deduce whether the consumable still comprises sufficient precursor material to assume that precursor material is available at the heater. As long as sufficient precursor material is present and thus available to be aerosolized, the aerosol generating apparatus may be operated as normal, e.g., by providing the designed amount of energy to the heater. Once it has been determined that precursor material is insufficient, i.e., depleted, the aerosol generating apparatus may initiate appropriate measures to avoid overheating of the heater. E.g., the energy provided to the heater may be reduced or completely switched off.

In order to determine the fill level of precursor material without specifically requiring a capacitance reference value or a calibration, it may be beneficial to provide a conduit element that is fluidly connecting the storage portion to the heating filament. The determine capacitance value may in particular related to the fill level of precursor material in the conduit element. E.g., it may be assumed that the conduit element is substantially filled, e.g., completely filled, with precursor material as long as there is sufficient precursor material available in the storage portion of the consumable. As such, the capacitance value may not change significantly even though the precursor material is successively used up by use of the aerosol generating apparatus by the user. In other words, the fill level of the conduit element and thus the related part of the capacitance value may have a larger contribution to the determined capacitance value so that the overall determined capacitance value may not change significantly as long as the conduit element is still filled with precursor material. Once the precursor material in the conduit element gets used up as well, this may have a larger influence on the determined capacitance value, so that a notable change in capacitance value may be related to the depletion of the precursor material within the conduit element, which may be an indication that the total precursor material is about to or has been used up.

In other words, the present disclosure relates to measure the capacitance of the liquid/precursor material in the consumable to determine the level. Two capacitor plates, e.g., two aluminium foils may be placed inside the consumable, each connected with each heating connector. The two aluminium foils work as capacitor. By measuring the capacitance feedback information of the liquid level inside the consumable may be obtained. A capacitance measurement may be combined with a tilt level sensor or an accelerometer or the like to provide information about the orientation of the aerosol generating apparatus. The reservoir/storage portion may have a thin conduit which fills with liquid, which may be the last portion the liquid is in before the heater/wick. This may provide a preferred reading of the capacitance if the capacitor plates surround this conduit. The capacitor plates may surround only the conduit, the wick element or the reservoir. The capacitor plates may surround one or more of these components. When there is little or no e-liquid, this can be detected by measuring the capacitance. The heating element may be prevented from operating as a result of low-level liquid determination.

The heater may be between capacitor plates. The heater may provide a constant capacitance value while the liquid provides a change thereof. Measuring capacitance of wick rather than the whole storage portion may suffice while measuring the whole storage portion may provide a larger changes, which may be more easily measurable. Positioning of the capacitance plate is variable, as only enough precursor material may be required to flow in between the capacitor plates so that a micro controller or processor may measure the capacitance value. The connections to the capacitor plates may be separate from the heater connections. The capacitor plates may be any suitable material like copper, steel or aluminium. The capacitor plates may be placed inside the consumable, inside the storage portion or outside the storage portion but within the consumable. The capacitor plates may be a printed coating. A specific location may result in a difference ii the measured capacitance range. In order to obtain a reliable capacitance measurement, a measurement may only be taken dependent on a certain orientation of the aerosol generating apparatus. A measurement may either be performed only when the device is substantially upright (i.e., may be triggered when the device is upright) or may be calculated from the current orientation. If measuring a conduit element and/or Wick only, use of a level sensor or an accelerometer may not be required.

In some examples, the consumable further comprises a wick, wherein the heating filament is attached to the wick and wherein the conduit element is fluidly connecting the storage portion to the wick.

In this way, the heating element may heat the wick. The wick may in particular be a porous material that receives precursor material from the storage portion via the conduit element and by teaching the wick, a preferable aerosolization of precursor material may be realized.

In some examples, only the conduit element is arranged in between the capacitor plates or only the conduit element and the wick is arranged in between the capacitor plates.

In this way, this may provide an improved reading of the capacitance if the capacitor plate surrounds this conduit and optionally the wick. In other words, the precise fill level of the storage portion with precursor material may not be taken into account or may not be relevant for determining the capacitance value, as the capacitance value is only related to the precursor material present in the conduit element and optionally the wick.

In some examples, the conduit element is arranged to be filled as long as the storage portion is at least partially filled with precursor material. In some examples, the processor is adapted to determine a capacitance value related to a fill level of precursor material in the conduit element. In some examples, the processor is adapted to determine a value step change in the capacitance value.

In this way, the capacitance value essentially remains unchanged regardless of the specific fill level of the storage portion with precursor material. Since the precursor material is provided to the heating filament and/or the wick exclusively through the conduit element (or a plurality of conduit elements), it can be assumed that precursor material is available at the heating filament and/or the wick, as long as the conduit element is filled and thus as long as the capacitance of value is unchanged. The capacitance value thus does not change for as long as the conduit element is filled with precursor material. The actual capacitance value is thus irrelevant. As long as the capacitance value remains substantially constant, it can be assumed that the conduit element is filled with precursor material and thus sufficient precursor material is available at the heating of filament for aerosolization. Once a change in the capacitance value is detected, it can be deduced that the precursor material in the storage portion is substantially depleted as no more precursor material is available in the storage portion to keep the conduit element filled. Such may thus be an indication that the consumable itself is depleted. Depending on the shape and size of the conduit element, a remaining use of the aerosol generating apparatus may be allowed. E.g., in case the conduit element allows storage of precursor material for a single use of the aerosol generating apparatus, the aerosol generating apparatus may prevent further use of the current consumable after conclusion of the current use, i.e., after conclusion of the current smoking cycle. In other examples, the shape and size of the conduit element may allow a different number of remaining smoking cycle of, e.g., two, three, four, five or more. In particular a step change in the capacitance value may indicate the depletion of precursor material in the storage portion. In other words, as long as the conduit element receives precursor material from the storage portion, the capacitance value remains unchanged, and the specific value of the capacitance value is less relevant. Once a change is detected, e.g., the conduit element depletes it precursor material within a single smoking cycle, the aerosol generating apparatus may prohibit further use of the current consumable. A step change as understood in the context of the present disclosure need not be an immediate change in capacitance value, e.g., a significant change within a certain tiny amount of time like for example a change of 10%, 20%, 30%, 40%, 50%, 60%, 70%, 80%, 90% or 100% within e.g., one second, two seconds, three seconds, four seconds, five seconds, 10 seconds, 15 seconds, 20 seconds, although this may be the case. In particular, it may suffice that the capacitance value exhibits a particular measurable change to deduce that the fill level of precursor material within the conduit element is lowering due to a depletion of precursor material in the storage portion.

In some examples, the processor is adapted to control the heating filament dependent on the capacitance value.

In some examples, the processor is adapted to stop supplying power to the heating filament dependent on the capacitance value.

In some examples, controlling the heating filament comprises stop supplying power to the heating filament dependent on the capacitance value.

In some examples, the method further comprises determining a value step change in the plurality of determined capacitance values and controlling the heating filament dependent on the determined value step change.

In this way, the device may initiate appropriate measures once a depletion of precursor material within the storage portion is detected or may be assumed. The heating filament may be controlled such that the temperature of the heating filament does not exceed a certain threshold temperature deemed inappropriate for the aerosol generating apparatus, so to avoid overheating of the heating filament and/or damage to the aerosol generating apparatus and/or an undesirable effect on the user. To avoid any such negative effect, it may be preferable to not supply energy to the heating filament at all, i.e., switching of the power supply to the heating filament. The controlling of the heating filament, e.g., the stopping of supplying power to the heating element may be dependent on a determined step change of the capacitance value. As long as the capacitance value remains substantially constant, it may be deduced that the conduit element receives precursor material from the storage portion and thus the consumable contains sufficient precursor material for the smoking operation of the aerosol generating apparatus. Once the capacitance value changes, it may be deduced that the precursor material in the storage portion is depleted. To this extent, a step change may exemplarily be understood as any change of the capacitance value, which may be an indication that the precursor material in the storage portion is depleted.

The preceding summary is provided for purposes of summarizing some examples to provide a basic understanding of aspects of the subject matter described herein. Accordingly, the above-described features should not be construed to narrow the scope or spirit of the subject matter described herein in any way. Moreover, the above and/or proceeding examples may be combined in any suitable combination to provide further examples, except where such a combination is clearly impermissible or expressly avoided. Other features, aspects, and advantages of the subject matter described herein will become apparent from the following text and the accompanying drawings.

### BRIEF DESCRIPTION OF THE FIGURES

Aspects, features and advantages of the present disclosure will become apparent from the following description of examples in reference to the appended drawings in which like numerals denote like elements.

FIG. 1 is a block system diagram showing an example aerosol generating apparatus.

FIG. 2 is a block system diagram showing an example implementation of the apparatus of FIG. 1, where the aerosol generating apparatus is configured to generate aerosol from a liquid precursor.

FIGS. 3a and 3b are schematic diagrams showing an example implementation of the apparatus of FIG. 2. FIG. 4 shows an exemplary embodiment of a consumable for an aerosol generating apparatus according to the present disclosure.

FIG. 5 shows an exemplary embodiment of a consumable for an aerosol generating apparatus according to the present disclosure.

FIG. 6 shows a further exemplary embodiment of a consumable for an aerosol generating apparatus according to the present disclosure.

FIG. 7 shows a flowchart for a method for heater control according to the present disclosure.

### DETAILED DESCRIPTION OF EMBODIMENTS

Before describing several examples implementing the present disclosure, it is to be understood that the present disclosure is not limited by specific construction details or process steps set forth in the following description and accompanying drawings. Rather, it will be apparent to those skilled in the art having the benefit of the present disclosure that the systems, apparatuses and/or methods described herein could be embodied differently and/or be practiced or carried out in various alternative ways.

Unless otherwise defined herein, scientific and technical terms used in connection with the presently disclosed inventive concept(s) shall have the meanings that are commonly understood by those of ordinary skill in the art and known techniques and procedures may be performed according to conventional methods well known in the art and as described in various general and more specific references that may be cited and discussed in the present specification.

Any patents, published patent applications, and non-patent publications mentioned in the specification are hereby incorporated by reference in their entirety.

All examples implementing the present disclosure can be made and executed without undue experimentation in light of the present disclosure. While particular examples have been described, it will be apparent to those of skill in the art that variations may be applied to the systems, apparatus, and/or methods and in the steps or in the sequence of steps of the methods described herein without departing from the concept, spirit, and scope of the inventive concept(s). All such similar substitutions and modifications apparent to those skilled in the art are deemed to be within the spirit, scope, and concept of the inventive concept(s) as defined by the appended claims.

The use of the term “a” or “an” in the claims and/or the specification may mean “one,” as well as “one or more,” “at least one,” and “one or more than one.” As such, the terms “a,” “an,” and “the,” as well as all singular terms, include plural referents unless the context clearly indicates otherwise. Likewise, plural terms shall include the singular unless otherwise required by context.

The use of the term “or” in the present disclosure (including the claims) is used to mean an inclusive “and/or” unless explicitly indicated to refer to alternatives only or unless the alternatives are mutually exclusive. For example, a condition “A or B” is satisfied by any of the following: A is true (or present), and B is false (or not present), A is false (or not present) and B is true (or present), and both A and B are true (or present).

As used in this specification and claim(s), the words “comprising, “having,” “including,” or “containing” (and any forms thereof, such as “comprise” and “comprises,” “have” and “has,” “includes” and “include,” or “contains” and “contain,” respectively) are inclusive or open-ended and do not exclude additional, unrecited elements or method steps.

Unless otherwise explicitly stated as incompatible, or the physics or otherwise of the embodiments, examples, or claims prevent such a combination, the features of examples disclosed herein, and of the claims, may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g., numbering) of example(s), embodiment(s), or dependency of claim(s). Moreover, this also applies to the phrase “in one embodiment,” “according to an embodiment,” and the like, which are merely a stylistic form of wording and are not to be construed as limiting the following features to a separate embodiment to all other instances of the same or similar wording. This is to say, a reference to ‘an,’ ‘one,’ or ‘some’ embodiment(s) may be a reference to any one or more, and/or all embodiments, or combination(s) thereof, disclosed. Also, similarly, the reference to “the” embodiment may not be limited to the immediately preceding embodiment. Further, all references to one or more embodiments or examples are to be construed as non-limiting to the claims.

The present disclosure may be better understood in view of the following explanations, wherein the terms used that are separated by “or” may be used interchangeably:

As used herein, an “aerosol generating apparatus” (or “electronic(e)-cigarette”) may be an apparatus configured to deliver an aerosol to a user for inhalation by the user. The apparatus may additionally/alternatively be referred to as a “smoking substitute apparatus”, if it is intended to be used instead of a conventional combustible smoking article. As used herein a combustible “smoking article” may refer to a cigarette, cigar, pipe or other article, that produces smoke (an aerosol comprising solid particulates and gas) via heating above the thermal decomposition temperature (typically by combustion and/or pyrolysis). An aerosol generated by the apparatus may comprise an aerosol with particle sizes of 0.2-7 microns, or less than 10 microns, or less than 7 microns. This particle size may be achieved by control of one or more of: heater temperature; cooling rate as the vapour condenses to an aerosol; flow properties including turbulence and velocity. The generation of aerosol by the aerosol generating apparatus may be controlled by an input device. The input device may be configured to be user-activated, and may for example include or take the form of an actuator (e.g., actuation button) and/or an airflow sensor.

Each occurrence of the aerosol generating apparatus being caused to generate aerosol for a period of time (which may be variable) may be referred to as an “activation” of the aerosol generating apparatus. The aerosol generating apparatus may be arranged to allow an amount of aerosol delivered to a user to be varied per activation (as opposed to delivering a fixed dose of aerosol), e.g. by activating an aerosol generating unit of the apparatus for a variable amount of time, e.g. based on the strength/duration of a draw of a user through a flow path of the apparatus (to replicate an effect of smoking a conventional combustible smoking article).

The aerosol generating apparatus may be portable. As used herein, the term “portable” may refer to the apparatus being for use when held by a user.

As used herein, an “aerosol generating system” may be a system that includes an aerosol generating apparatus and optionally other circuitry/components associated with the function of the apparatus, e.g., one or more external devices and/or one or more external components (here “external” is intended to mean external to the aerosol generating apparatus). As used herein, an “external device” and “external component” may include one or more of a: a charging device, a mobile device (which may be connected to the aerosol generating apparatus, e.g., via a wireless or wired connection); a networked-based computer (e.g. a remote server); a cloud-based computer; any other server system.

An example aerosol generating system may be a system for managing an aerosol generating apparatus. Such a system may include, for example, a mobile device, a network server, as well as the aerosol generating apparatus.

As used herein, an “aerosol” may include a suspension of precursor, including as one or more of: solid particles; liquid droplets; gas. Said suspension may be in a gas including air. An aerosol herein may generally refer to/include a vapour. An aerosol may include one or more components of the precursor. As used herein, a “precursor” may include one or more of a: liquid; solid; gel; loose leaf material; other substance. The precursor may be processed by an aerosol generating unit of an aerosol generating apparatus to generate an aerosol. The precursor may include one or more of: an active component; a carrier; a flavouring. The active component may include one or more of nicotine; caffeine; a cannabidiol oil; a non-pharmaceutical formulation, e.g., a formulation which is not for treatment of a disease or physiological malfunction of the human body. The active component may be carried by the carrier, which may be a liquid, including propylene glycol and/or glycerine. The term “flavouring” may refer to a component that provides a taste and/or a smell to the user. The flavouring may include one or more of: Ethylvanillin (vanilla); menthol, Isoamyl acetate (banana oil); or other. The precursor may include a substrate, e.g., reconstituted tobacco to carry one or more of the active component; a carrier; a flavouring.

As used herein, a “storage portion” may be a portion of the apparatus adapted to store the precursor. It may be implemented as fluid-holding reservoir or carrier for solid material depending on the implementation of the precursor as defined above.

As used herein, a “flow path” may refer to a path or enclosed passageway through an aerosol generating apparatus, e.g., for delivery of an aerosol to a user. The flow path may be arranged to receive aerosol from an aerosol generating unit. When referring to the flow path, upstream and downstream may be defined in respect of a direction of flow in the flow path, e.g., with an outlet being downstream of an inlet.

As used herein, a “delivery system” may be a system operative to deliver an aerosol to a user. The delivery system may include a mouthpiece and a flow path.

As used herein, a “flow” may refer to a flow in a flow path. A flow may include aerosol generated from the precursor. The flow may include air, which may be induced into the flow path via a puff by a user. As used herein, a “puff” (or “inhale” or “draw”) by a user may refer to expansion of lungs and/or oral cavity of a user to create a pressure reduction that induces flow through the flow path.

As used herein, an “aerosol generating unit” may refer to a device configured to generate an aerosol from a precursor. The aerosol generating unit may include a unit to generate a vapour directly from the precursor (e.g., a heating system or other system) or an aerosol directly from the precursor (e.g. an atomiser including an ultrasonic system, a flow expansion system operative to carry droplets of the precursor in the flow without using electrical energy or other system). A plurality of aerosol generating units to generate a plurality of aerosols (for example, from a plurality of different aerosol precursors) may be present in an aerosol generating apparatus.

As used herein, a “heating system” may refer to an arrangement of at least one heating element, which is operable to aerosolise a precursor once heated. The at least one heating element may be electrically resistive to produce heat from the flow of electrical current therethrough. The at least one heating element may be arranged as a susceptor to produce heat when penetrated by an alternating magnetic field. The heating system may be configured to heat a precursor to below 300 or 350 degrees C, including without combustion.

As used herein, a “consumable” may refer to a unit that includes a precursor. The consumable may include an aerosol generating unit, e.g., it may be arranged as a cartomizer. The consumable may include a mouthpiece. The consumable may include an information carrying medium. With liquid or gel implementations of the precursor, e.g., an e-liquid, the consumable may be referred to as a “capsule” or a “pod” or an “e-liquid consumable”. The capsule/pod may include a storage portion, e.g., a reservoir or tank, for storage of the precursor. With solid material implementations of the precursor, e.g., tobacco or reconstituted tobacco formulation, the consumable may be referred to as a “stick” or “package” or “heat-not-burn consumable”. In a heat-not-burn consumable, the mouthpiece may be implemented as a filter and the consumable may be arranged to carry the precursor. The consumable may be implemented as a dosage or pre-portioned amount of material, including a loose-leaf product.

As used herein, an “information carrying medium” may include one or more arrangements for storage of information on any suitable medium. Examples include: a computer readable medium; a Radio Frequency Identification (RFID) transponder; codes encoding information, such as optical (e.g., a bar code or QR code) or mechanically read codes (e.g. a configuration of the absence or presents of cut-outs to encode a bit, through which pins or a reader may be inserted).

As used herein “heat-not-burn” (or “HNB” or “heated precursor”) may refer to the heating of a precursor, typically tobacco, without combustion, or without substantial combustion (i.e., localised combustion may be experienced of limited portions of the precursor, including of less than 5% of the total volume).

As used herein, “electrical circuitry” may refer to one or more electrical components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the apparatus, or distributed between the apparatus and/or on one or more external devices in communication with the apparatus, e.g., as part of a system.

As used herein, a “processing resource” (or “processor” or “controller”) may refer to one or more units for processing data, examples of which may include an ASIC, microcontroller, FPGA, microprocessor, digital signal processor (DSP) capability, state machine or other suitable component. A processing resource may be configured to execute a computer program, e.g., which may take the form of machine-readable instructions, which may be stored on a non-transitory memory and/or programmable logic. The processing resource may have various arrangements corresponding to those discussed for the circuitry, e.g., on-board and/or off board the apparatus as part of the system. As used herein, any machine executable instructions, or computer readable media, may be configured to cause a disclosed method to be carried out, e.g., by an aerosol generating apparatus or system as disclosed herein, and may therefore be used synonymously with the term method.

As used herein, an “external device” (or “peripheral device”) may include one or more electronic components external to an aerosol generating apparatus. Those components may be arranged at the same location as the aerosol generating apparatus or remote from the apparatus. An external device may comprise electronic computer devices including: a smartphone; a PDA; a video game controller; a tablet; a laptop; or other like device.

As used herein, a “computer readable medium/media” (or “memory” or “data storage”) may include any medium capable of storing a computer program, and may take the form of any conventional non-transitory memory, for example one or more of: random access memory (RAM); a CD; a hard drive; a solid-state drive; a memory card; a DVD. The memory may have various arrangements corresponding to those discussed for the circuitry/processor. The present disclosure includes a computer readable medium configured to cause an apparatus or system disclosed herein to perform a method as disclosed herein.

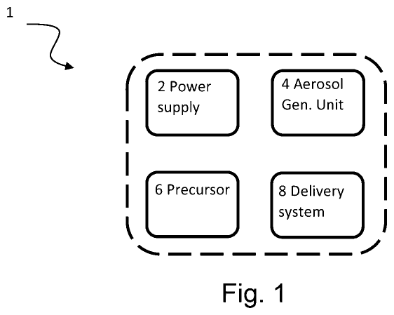

Referring to FIG. 1, an example aerosol generating apparatus 1 includes a power supply 2, for supply of electrical energy. The apparatus 1 includes an aerosol generating unit 4 that is driven by the power supply 2. The power supply 2 may include an electric power supply in the form of a battery and/or an electrical connection to an external power source. The apparatus 1 includes a precursor 6, which in use is aerosolised by the aerosol generating unit 4 to generate an aerosol. The apparatus 2 includes a delivery system 8 for delivery of the aerosol to a user.

Electrical circuitry (not shown in FIG. 1) may be implemented to control the interoperability of the power supply 4 and aerosol generating unit 6.

In variant examples, which are not illustrated, the power supply 2 may be omitted since, e.g., an aerosol generating unit implemented as an atomiser with flow expansion may not require a power supply.

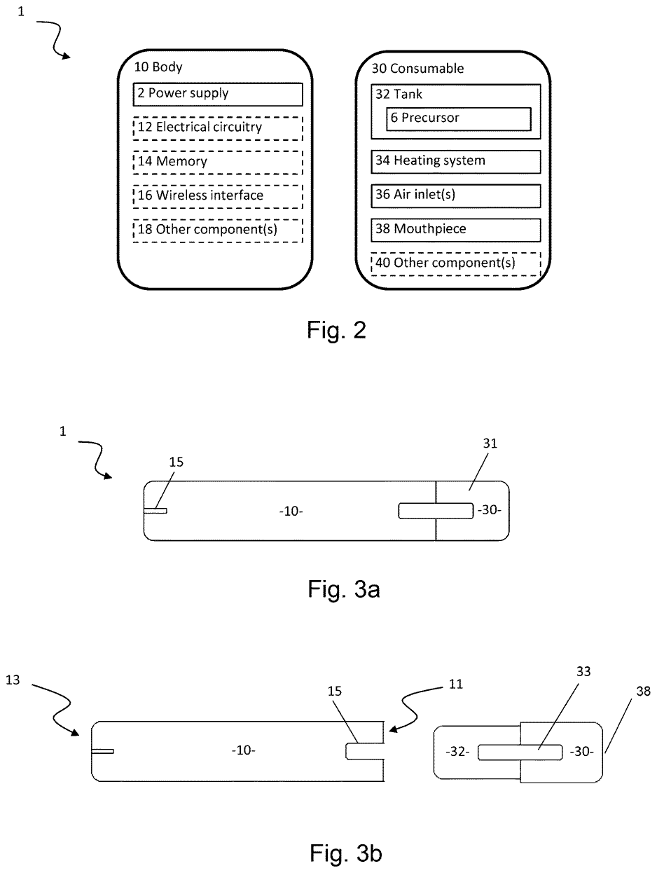

FIG. 2 shows an implementation of the apparatus 1 of FIG. 1, where the aerosol generating apparatus 1 is configured to generate aerosol from a liquid precursor.

In this example, the apparatus 1 includes a device body 10 and a consumable 30.

In this example, the body 10 includes the power supply 4. The body may additionally include any one or more of electrical circuitry 12, a memory 14, a wireless interface 16, one or more other components 18.

The electrical circuitry 12 may include a processing resource for controlling one or more operations of the body 10 and consumable 30, e.g., based on instructions stored in the memory 14.

The wireless interface 16 may be configured to communicate wirelessly with an external (e.g., mobile) device, e.g. via Bluetooth.

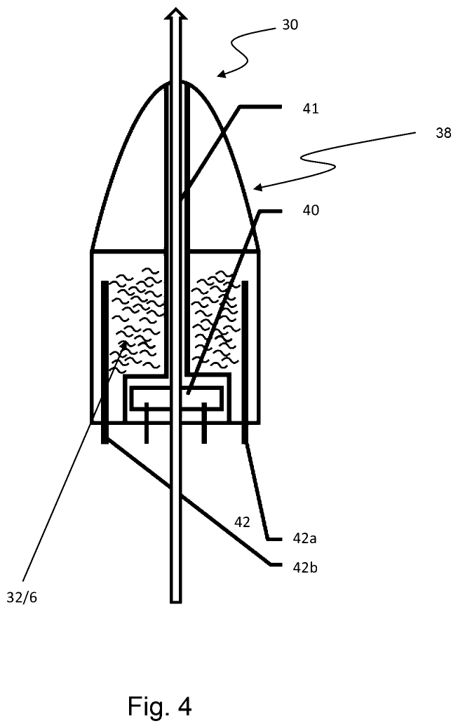

The other component(s) 18 may include one or more user interface devices configured to convey information to a user and/or a charging port, for example (see e.g., FIG. 3).

The consumable 30 includes a storage portion implemented here as a tank 32 which stores the liquid precursor 6 (e.g., e-liquid). The consumable 30 also includes a heating system 34, one or more air inlets 36, and a mouthpiece 38. The consumable 30 may include one or more other components 40.

The body 10 and consumable 30 may each include a respective electrical interface (not shown) to provide an electrical connection between one or more components of the body 10 with one or more components of the consumable 30. In this way, electrical power can be supplied to components (e.g., the heating system 34) of the consumable 30, without the consumable 30 needing to have its own power supply.

In use, a user may activate the aerosol generating apparatus 1 when inhaling through the mouthpiece 38, i.e., when performing a puff. The puff, performed by the user, may initiate a flow through a flow path in the consumable 30 which extends from the air inlet(s) 34 to the mouthpiece 38 via a region in proximity to the heating system 34.

Activation of the aerosol generating apparatus 1 may be initiated, for example, by an airflow sensor in the body 10 which detects airflow in the aerosol generating apparatus 1 (e.g., caused by a user inhaling through the mouthpiece), or by actuation of an actuator included in the body 10. Upon activation, the electrical circuitry 12 (e.g., under control of the processing resource) may supply electrical energy from the power supply 2 to the heating system 34 which may cause the heating system 32 to heat liquid precursor 6 drawn from the tank to produce an aerosol which is carried by the flow out of the mouthpiece 38.

In some examples, the heating system 34 may include a heating filament and a wick, wherein a first portion of the wick extends into the tank 32 in order to draw liquid precursor 6 out from the tank 32, wherein the heating filament coils around a second portion of the wick located outside the tank 32. The heating filament may be configured to heat up liquid precursor 6 drawn out of the tank 32 by the wick to produce the aerosol.

In this example, the aerosol generating unit 4 is provided by the above-described heating system 34 and the delivery system 8 is provided by the above-described flow path and mouthpiece 38.

In variant embodiments (not shown), any one or more of the precursor 6, heating system 34, air inlet(s) 36 and mouthpiece 38, may be included in the body 10. For example, the mouthpiece 36 may be included in the body 10 with the precursor 6 and heating system 32 arranged as a separable cartomizer. FIGS. 3a and 3b show an example implementation of the aerosol generating device 1 of FIG. 2. In this example, the consumable 30 is implemented as a capsule/pod, which is shown in FIG. 3a as being physically coupled to the body 10, and is shown in FIG. 3b as being decoupled from the body 10.

In this example, the body 10 and the consumable 30 are configured to be physically coupled together by pushing the consumable 30 into an aperture in a top end 11 the body 10, with the consumable 30 being retained in the aperture via an interference fit.

In other examples (not shown), the body 10 and the consumable 30 could be physically coupled together in other ways, e.g., by screwing one onto the other, through a bayonet fitting, or through a snap engagement mechanism, for example.

The body 10 also includes a charging port (not shown) at a bottom end 13 of the body 10.

The body 10 also includes a user interface device configured to convey information to a user. Here, the user interface device is implemented as a light 15, which may e.g., be configured to illuminate when the apparatus 1 is activated. Other user interface devices are possible, e.g., to convey information haptically or audibly to a user.

In this example, the consumable 30 has an opaque cap 31, a translucent tank 32 and a translucent window 33. When the consumable 30 is physically coupled to the body 10 as shown in FIG. 3a, only the cap 31 and window 33 can be seen, with the tank 32 being obscured from view by the body 10. The body 10 includes a slot 15 to accommodate the window 33. The window 33 is configured to allow the amount of liquid precursor 6 in the tank 32 to be visually assessed, even when the consumable 30 is physically coupled to the body 10.

Referring to FIG. 4, a consumable 30 for an aerosol generating apparatus 1 is depicted. The consumable 30 is only depicted schematically, comprises a mouthpiece 38 and has an air flow path 41. The air flow path 41 is in fluid connection with a heating filament 40 as depicted by the upward arrow in FIG. 4. The consumable 30 comprises a storage portion 32 containing precursor material 6. Not specifically depicted in FIG. 4, the precursor material 6 arrives at the heating filament 40 and is aerosolized for inhalation by a user of the aerosol generating apparatus 1, dependent on the temperature of the heating filament 40. In other words, in case the heating filament 40 has a sufficiently high temperature, the precursor material 6 is aerosolized and a user inhaling through the mouthpiece 38 is inhaling a mixture of air and aerosolized precursor material 6. The storage portion 32 is not specifically depicted as a container in the interior of consumable 30.

In the interior of the consumable, the sensor arrangement 42 is provided to determine a capacitance value that is related to a fillable of precursor material 6 within the storage portion 32 or generally within the consumable 30. The sensor arrangement 42 exemplarily comprises two capacitor plates 42a, b, arranged at opposing sides of the storage portion 32, thus accommodating the storage portion 32 within the volume between the capacitor plates 42a, b. In FIG. 4, in addition to the storage portion 32, also the heating filament 40 is arranged within the volume between the capacitor plates 42a, b. The heating filament 40 may further comprise a wick, which is however not depicted in FIG. 4.

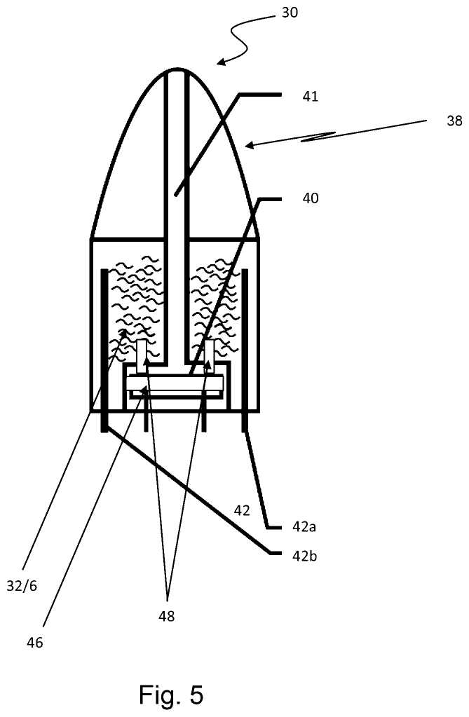

In this regard, a reduction of the level of precursor material 6 within the storage portion 32 results in a change of the capacitance of value of the sensor arrangement 42, i.e., a change in the capacitance between the capacitor plates 42a, b. The capacitor plates 42a, b may be connected to a processor or the like, e.g., electrical circuit 12, not depicted in FIG. 4, for determination of the capacitance value. Referring to FIG. 5, the consumable 30 according to FIG. 4 is depicted additionally comprising a wick 46 and a conduit element 48, exemplarily embodied as to conduit elements 48 symmetrically arranged adjacent to the air flow path 41. Conduit elements 48 fluidly connect the storage portion 36 with the heating filament 40 and in particular the wick 46. In other words, precursor material 6 stored in the storage portion 32 is able to pass through conduit elements 48, i.e., flow through conduit elements 48, two the heating filament 40 and/or the wick 46. The precursor material 6 may be heated, e.g., aerosolized, by the heating filament 40 and/or wick 46, which in turn may be heated by the heating filament 40. The aerosol generated by aerosolization of the precursor material 6 by the heating filament 40/wick 46 mixes with air and is transported through airflow channel 41 to the user, when the user inhales through the mouthpiece 38. Again in FIG. 5, the capacitor plates 42a, b of the sensor arrangement 42 surround the storage portion 32, the heating filament 40, the wick 46 and the conduit elements 48.

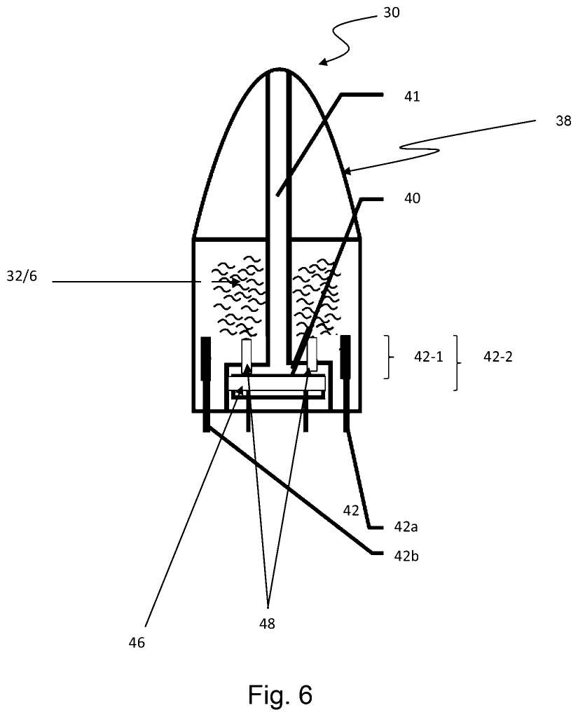

Referring to FIG. 6, the consumable 30 essentially corresponds to the consumable 30 depicted with regard to FIG. 5. However, the capacitor plates 42a, b now have essentially only the conduit elements 48 between them. Thus, the measured capacitance value of the sensor arrangement 42 depends essentially only on the precursor material 6 within the conduit elements 48. As such, the capacitance of value remains substantially unchanged during the lifetime of the consumable as long as there is sufficient precursor material 6 in the storage portion 32. Once the precursor material 6 in the storage portion 32 is depleted, the precursor material 6 within the conduit elements 48 is becoming depleted as well, thus resulting in a change of the capacitance value of the sensor arrangement 42. In this regard, the capacitor plates 42a, b are only arranged as depicted by bracket 42-1 having the conduit elements in between.

Alternatively, as indicated by bracket 42-2, the capacitor plates 42a, b of the sensor arrangement 42 may be arranged to have the conduit elements 48 and the wick 46 in between. In this exemplary embodiment, the step change in capacitance value of sensor arrangement is related to the depletion of precursor material 6 within the conduit elements 48 and the wick 46.

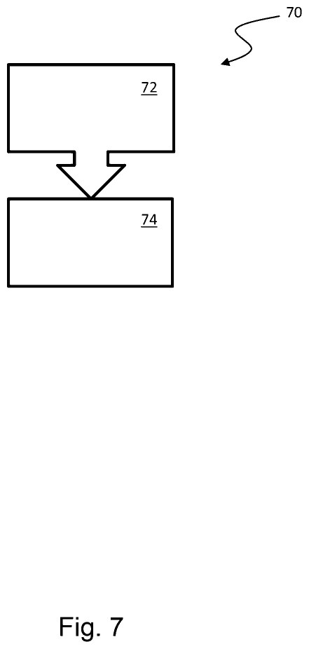

Referring to FIG. 7, a method 70 for heater control of a consumable 30 is depicted, comprising the steps of determining 72 a plurality of capacitance values related to a fill level of precursor material 6 in the storage portion 32, and controlling 74 the heating filament 40 dependent on at least one of the plurality of capacitance value or a change in capacitance value.

1. Consumable (30) for an aerosol generating apparatus (1), comprising
a storage portion (32) for storing a precursor material (6);
a heating filament (40) for heating the precursor material (6); and
a sensor arrangement (42), comprising
two capacitor plates (42a, b);
wherein at least a part of the storage portion (32) is arranged between the capacitor plates (42a, b);
wherein the sensor arrangement (42) is adapted to determine a capacitance value related to a fill level of precursor material (6) in the storage portion (32),
wherein the storage portion (32) comprises a conduit element (48) fluidly connecting the storage portion (32) to the heating filament (40); and
wherein the sensor arrangement (42) is adapted to determine a capacitance value related to the fill level of precursor material (6) in the conduit element (48).

2. Consumable according to the preceding claim, further comprising
a wick (46),
wherein the heating filament (40) is attached to the wick (46), and
wherein the conduit element (48) is fluidly connecting the storage portion (32) to the wick (46).

3. Consumable according to at least one of the preceding claims,
wherein (42-1) only the conduit element (48) is arranged in between the capacitor plates (42a, b), or
wherein (42-2) only the conduit element (48) and the wick (46) are arranged in between the capacitor plates (42a, b).

4. Consumable according to at least one of the preceding claims,
wherein the conduit element (48) is arranged to be filled as long as the storage portion (32) is at least partially filled with precursor material (6).

5. Set of aerosol generating apparatus (1) and a consumable (30) according to at least one of the preceding claims,
wherein the aerosol generating apparatus (1) comprises a processor; and
wherein the processor is adapted to determine a capacitance value related to a fill level of precursor material (6) in the storage portion (32).

6. Set according to the preceding claim,
wherein the processor is adapted to determine a capacitance value related to a fill level of precursor material (6) in the conduit element (48).

7. Set according to at least one of the preceding claims,
wherein the processor is adapted to determine a value step change in the capacitance value.

8. Set according to at least one of the preceding claims,
wherein the processor is adapted to control the heating filament (40) dependent on the capacitance value.

9. Set according to at least one of the preceding claims,
wherein the processor is adapted to stop supplying power to the heating filament (40) dependent on the capacitance value.

10. A method (70) for heater control of a consumable (30) according to at least one of the preceding claims, comprising the steps of
determine (72) a plurality of capacitance values related to a fill level of precursor material (6) in the storage portion (32), and
control (74) the heating filament (40) dependent on at least one of the plurality of capacitance value or a change in capacitance value.

11. The method according to the preceding claim, further comprising
determine (74) a value step change in the plurality of determined capacitance values, and
control the heating filament dependent on the determined value step change.

12. The method according to at least one of the preceding claims,
wherein controlling the heating filament (40) comprises stop supplying power to the heating filament dependent (40) on the capacitance value.

13. A computer-readable storage medium or a computer program product comprising instructions which, when executed by a processor, cause the processor to carry out the method (70) according to at least one of the preceding claims.
